(19) United States
(12) Patent Application Publication
(10) Pub. No.: US 2010/0268613 A1
(43) Pub. Date: Oct. 21, 2010

(54) SYSTEMS AND METHODS FOR CAPTURING AND TRANSMITTING TRANSACTIONAL DATA RELATED TO PRODUCT AND SERVICE SALES

(75) Inventors: Adam N. Lindahl, Holmes Beach, FL (US); Michael D. Madden, Manhasset, NY (US); Mel A. Shaftel, New York, NY (US)

Correspondence Address: AMSTER, ROTHSTEIN & EBENSTEIN LLP, 90 PARK AVENUE, NEW YORK, NY, 10016, US

(73) Assignee: GreenReceipts, Longboat Key, FL (US)

(21) Appl. No.: 12/709,235

(22) Filed: Feb. 19, 2010

Related U.S. Application Data
(63) Continuation of application No. 12/708,285, filed on Feb. 18, 2010.
(60) Provisional application No. 61/154,426, filed on Feb. 22, 2009.

(51) Int. Cl. G06Q 20/00; G06Q 40/00

(52) U.S. Cl. 705/16; 705/44; 235/380

(57) ABSTRACT

Systems and methods for capturing and managing information from a plurality of individual items sold in a commercial transaction between a consumer and a merchant can include capturing, at a point-of-sale, transactional data for the a plurality of individual items sold during the transaction. The transactional data can include item identification information for each of the a plurality of individual items sold. The transactional data can further be used to authorize the transaction.

### CROSS-REFERENCE TO RELATED APPLICATIONS

This application is a continuation of U.S. patent application Ser. No. 12/708,285 which claims priority to U.S. Provisional Patent Application No. 61/154,426, filed Feb. 22, 2009, the content of which are incorporated herein by reference in their entirety.

### FIELD OF THE INVENTION

The present invention generally relates to systems and methods for capturing and managing electronic transactional dated related to the purchase of goods and/or services.

### SUMMARY OF THE INVENTION

In exemplary embodiments, a method for capturing and managing information from one or more individual items sold in a commercial transaction between a consumer and a merchant can comprise receiving, at one or more computers from a point-of sale device transactional data, wherein the transactional data can relate to a plurality of individual items sold during the transaction, the transactional data can comprise item identification information for each of the plurality of individual items sold and account information. The method can further comprise storing the transactional data in one or more databases on one or more processor readable memory electronically accessible by the one or more computers, electronically categorizing using the one or more computers each of the a plurality of individual items sold according to the item identification information; and generating, using the one or more computers, a report organized according to the item identification information for the a plurality of individual items sold.

In exemplary embodiments, the report can be used for corporate governance and/or auditing purposes. The report can further comprise location based information and the location base information can be generated on a map. The report can be used by at least one of a parent monitoring the spending of a child and a university monitoring the spending of a student.

In exemplary embodiments, the transactional data and/or report can be viewed on a mobile electronic device.

In exemplary embodiments, the account information can be captured through a portal in a mobile electronic device, input manually, and/or captured from a card. The card can be affiliated with multiple credit cards.

In exemplary embodiments, the report can aggregate account information from a plurality of credit cards and/or a plurality of accounts. The report can also be transmitted via email and/or the report can be accessed on the internet or other secure connection.

In exemplary embodiments, the item identification information can comprise the type and/or category of the individual items sold.

In exemplary embodiments, the method can comprise electronically determining a relationship between each of the a plurality of individual items sold and items from existing purchases stored in the database on one or more processor readable memory based on the item identification information. The step of electronically categorizing each of the plurality of individual items sold can further comprise electronically categorizing each of the a plurality of individual items sold and the items from existing purchases according to the item identification information. The step of generating the report can further comprise generating a report that can comprise the plurality of individual items sold and the items from existing purchases organized according to the item identification information.

In exemplary embodiments, the method can further comprise transmitting to an additional computer the generated report for modification of the item identification information.

In exemplary embodiments, the generated report can be a report for at least one of accounting purposes and government filing purposes.

In exemplary embodiments, the transactional data refers to transactions related to at least one of a house, a car, and a boat.

In exemplary embodiments, the item identification information can be a SKU number.

In exemplary embodiments, the transactional data can be generated at the point of sale and/or input at the point of sale.

In exemplary embodiments, a method for storing data about a plurality of individual items sold in a commercial transaction between a consumer and a merchant can comprise receiving, at one or more computers transactional data, wherein the transactional data can relate to a plurality of individual items sold during the transaction, the transactional data can comprise item identification information for each of the plurality of individual items sold and account information. The method can further comprise storing the transactional data in one or more databases on one or more processor readable memory electronically accessible by the one or more computers; transmitting the transactional data to one or more computer to generate a report that can be organized according to the item identification information for the a plurality of individual items sold.

In exemplary embodiments, the report can be used for corporate governance and/or auditing purposes. The report can further comprise location based information and the location base information can be generated on a map. The report can be used by at least one of a parent monitoring the spending of a child and a university monitoring the spending of a student.

In exemplary embodiments, the transactional data and/or report can be viewed on a mobile electronic device.

In exemplary embodiments, the account information can be captured through a portal in a mobile electronic device, input manually, and/or captured from a card. The card can be affiliated with multiple credit cards.

In exemplary embodiments, the report can aggregate account information from a plurality of credit cards and/or a plurality of accounts. The report can also be transmitted via email and/or the report can be accessed on the internet or other secure connection.

In exemplary embodiments, the item identification information can comprise the type and/or category of the individual items sold.

In exemplary embodiments, the method can further comprise electronically categorizing using the one or more computers each of the a plurality of individual items sold according to the item identification information. The method can comprise electronically determining a relationship between each of the a plurality of individual items sold and items from existing purchases stored in the database on one or more processor readable memory based on the item identification information. The step of electronically categorizing each of the plurality of individual items sold can further comprise electronically categorizing each of the a plurality of individual items sold and the items from existing purchases according to the item identification information. The step of generating the report can further comprise generating a report that can comprise the plurality of individual items sold and the items from existing purchases organized according to the item identification information.

In exemplary embodiments, the method can further comprise transmitting to an additional computer the generated report for modification of the item identification information.

In exemplary embodiments, the generated report can be a report for at least one of accounting purposes and government filing purposes.

In exemplary embodiments, the transactional data refers to transactions related to at least one of a house, a car, and a boat.

In exemplary embodiments, the item identification information can be a SKU number.

In exemplary embodiments, the transactional data can be generated at the point of sale and/or input at the point of sale.

In exemplary embodiments, a method for accessing and managing from a customer access point capturing information for a plurality of items sold in a commercial transaction between a consumer and a merchant can comprise receiving, at one or more computers at a customer access point, transactional data, wherein the transactional data relates to a plurality of individual items sold during the transaction, the transactional data can comprise item identification information for each of the plurality of individual items sold and account information. The method can further comprise storing the transactional data in one or more databases on one or more processor readable memory electronically accessible by the one or more computers; generating a report, using one or more computers, using the transactional data such that each of the plurality of individual items sold during at least one commercial transaction is placed in the report; and displaying, using one or more computers, on a graphical user interface the report.

In exemplary embodiments, the report can be used for corporate governance and/or auditing purposes. The report can further comprise location based information and the location base information can be generated on a map. The report can be used by at least one of a parent monitoring the spending of a child and a university monitoring the spending of a student.

In exemplary embodiments, the transactional data and/or report can be viewed on a mobile electronic device.

In exemplary embodiments, the account information can be captured through a portal in a mobile electronic device, input manually, and/or captured from a card. The card can be affiliated with multiple credit cards.

In exemplary embodiments, the report can aggregate account information from a plurality of credit cards and/or a plurality of accounts. The report can also be transmitted via email and/or the report can be accessed on the internet or other secure connection.

In exemplary embodiments, the item identification information can comprise the type and/or category of the individual items sold.

In exemplary embodiments, the method can comprise electronically determining a relationship between each of the a plurality of individual items sold and items from existing purchases stored in the database on one or more processor readable memory based on the item identification information. The step of electronically categorizing each of the plurality of individual items sold can further comprise electronically categorizing each of the a plurality of individual items sold and the items from existing purchases according to the item identification information. The step of generating the report can further comprise generating a report that can comprise the plurality of individual items sold and the items from existing purchases organized according to the item identification information.

In exemplary embodiments, the method can further comprise transmitting to an additional computer the generated report for modification of the item identification information.

In exemplary embodiments, the generated report can be a report for at least one of accounting purposes and government filing purposes.

In exemplary embodiments, the transactional data refers to transactions related to at least one of a house, a car, and a boat.

In exemplary embodiments, the item identification information can be a SKU number.

In exemplary embodiments, the transactional data can be generated at the point of sale and/or input at the point of sale.

In exemplary embodiments, a method for approving or denying a plurality of items sold in a commercial transaction between a consumer and a merchant can comprise receiving, at one or more computers transactional data, wherein the transactional data can relate to a plurality of individual items sold during the transaction, the transactional data comprising item identification information for each of the plurality of individual items sold and account information. The method can further comprise storing the transactional data in one or more databases on one or more processor readable memory electronically accessible by the one or more computers; electronically categorizing using the one or more computers each of the a plurality of individual items sold according to the item identification information; analyzing, using one or more computers, electronically categorized plurality of individual items sold to deny or approve at least one of the individual item sold and the entire purchase using at least one deny or approve rule; and transmitting at least one of approval or denial for at least one individual item and the entire purchase.

In exemplary embodiments, the transmitted approval or denial and transactional data can be used generate a report. The report can be used for corporate governance and/or auditing purposes. The report can further comprise location based information and the location base information can be generated on a map. The report can be used by at least one of a parent monitoring the spending of a child and a university monitoring the spending of a student.

In exemplary embodiments, the transactional data and/or report can be viewed on a mobile electronic device.

In exemplary embodiments, the account information can be captured through a portal in a mobile electronic device, input manually, and/or captured from a card. The card can be affiliated with multiple credit cards.

In exemplary embodiments, the report can aggregate account information from a plurality of credit cards and/or a plurality of accounts. The report can also be transmitted via email and/or the report can be accessed on the internet or other secure connection.

In exemplary embodiments, the item identification information can comprise the type and/or category of the individual items sold.

In exemplary embodiments, the method can comprise electronically determining a relationship between each of the a plurality of individual items sold and items from existing purchases stored in the database on one or more processor readable memory based on the item identification information. The step of electronically categorizing each of the plurality of individual items sold can further comprise electronically categorizing each of the a plurality of individual items sold and the items from existing purchases according to the item identification information. The step of generating the report can further comprise generating a report that can comprise the plurality of individual items sold and the items from existing purchases organized according to the item identification information.

In exemplary embodiments, the method can further comprise transmitting to an additional computer the generated report for modification of the item identification information.

In exemplary embodiments, the generated report can be a report for at least one of accounting purposes and government filing purposes.

In exemplary embodiments, the transactional data refers to transactions related to at least one of a house, a car, and a boat.

In exemplary embodiments, the item identification information can be a SKU number.

In exemplary embodiments, the transactional data can be generated at the point of sale and/or input at the point of sale.

In exemplary embodiments, a method of capturing and transmitting data for a plurality of items sold in a commercial transaction between a consumer and a merchant can comprise receiving, at one or more computers transactional data, wherein the transactional data can relate to a plurality of individual items sold during the transaction, the transactional data comprising item identification information for each of the plurality of individual items sold and account information. The method can further comprise storing the transactional data on one or more processor readable memory electronically accessible by the one or more computers; transmitting the transactional data for approval or denial for at least a plurality of items and the entire purchase; receiving approval or denial for at least a plurality of items and the entire purchase; and transmitting the transactional data to a database.

In exemplary embodiments, the transmitted transactional data can be used to generate a report. The report can be used for corporate governance and/or auditing purposes. The report can further comprise location based information and the location base information can be generated on a map. The report can be used by at least one of a parent monitoring the spending of a child and a university monitoring the spending of a student.

In exemplary embodiments, the transactional data and/or report can be viewed on a mobile electronic device.

In exemplary embodiments, the account information can be captured through a portal in a mobile electronic device, input manually, and/or captured from a card. The card can be affiliated with multiple credit cards.

In exemplary embodiments, the report can aggregate account information from a plurality of credit cards and/or a plurality of accounts. The report can also be transmitted via email and/or the report can be accessed on the internet or other secure connection.

In exemplary embodiments, the item identification information can comprise the type and/or category of the individual items sold.

In exemplary embodiments, the method can comprise electronically determining a relationship between each of the a plurality of individual items sold and items from existing purchases stored in the database on one or more processor readable memory based on the item identification information. The step of electronically categorizing each of the plurality of individual items sold can further comprise electronically categorizing each of the a plurality of individual items sold and the items from existing purchases according to the item identification information. The step of generating the report can further comprise generating a report that can comprise the plurality of individual items sold and the items from existing purchases organized according to the item identification information.

In exemplary embodiments, the method can further comprise transmitting to an additional computer the generated report for modification of the item identification information.

In exemplary embodiments, the generated report can be a report for at least one of accounting purposes and government filing purposes.

In exemplary embodiments, the transactional data refers to transactions related to at least one of a house, a car, and a boat.

In exemplary embodiments, the item identification information can be a SKU number.

In exemplary embodiments, the transactional data can be generated at the point of sale and/or input at the point of sale. These and other features of this invention are described in, or are apparent from, the following detailed description of various exemplary embodiments of this invention.

### BRIEF DESCRIPTION OF THE DRAWINGS

The features and advantages of the present invention will be more fully understood with reference to the following, detailed description of exemplary embodiments of the present invention when taken in conjunction with the accompanying figures, wherein:

FIG. 1 is a block diagram of embodiments of the present invention;

FIGS. 1A-1E are block diagrams of embodiments of certain components of the present invention;

FIG. 2 is a block diagram of embodiments of certain components of the system and method of FIG. 1;

FIG. 3 is a flow chart of embodiments of the present invention;

FIG. 4 is a flow chart of embodiments of the present invention;

FIGS. 5 is an example screenshot of an implementation of embodiments of the present invention;

FIG. 6 is an example screenshot of an implementation of embodiments of the present invention; and

FIG. 7 is an example screenshot of an implementation of embodiments of the present invention.

### DETAILED DESCRIPTION OF THE EXEMPLARY EMBODIMENTS

The present invention generally relates to systems and methods for capturing and managing electronic transactional dated related to the purchase of goods and/or services.

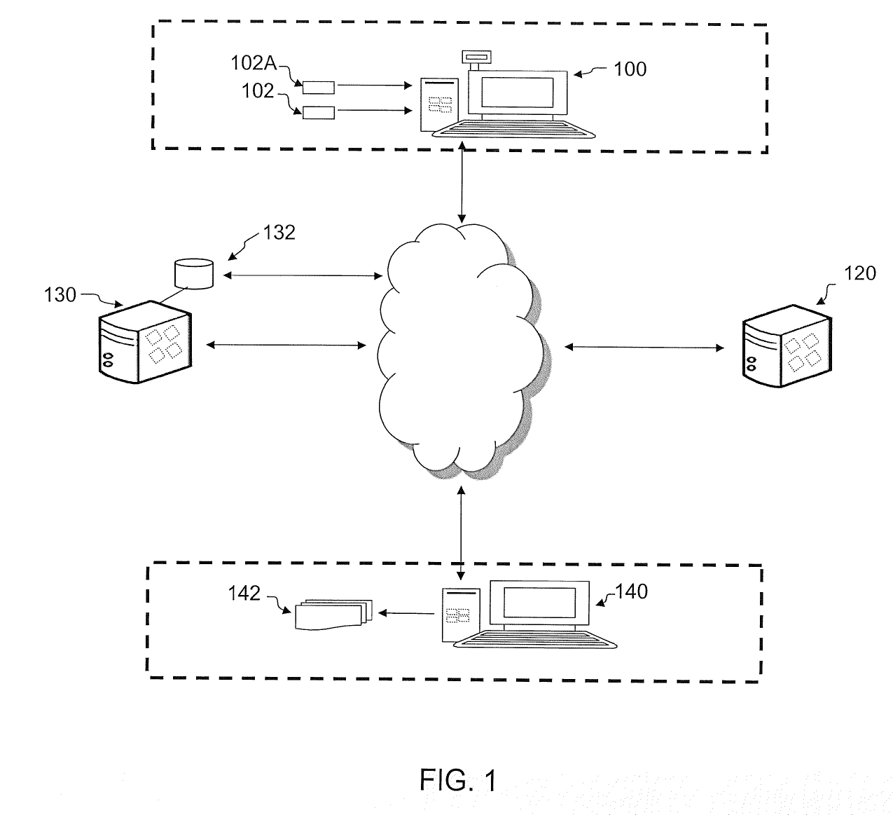

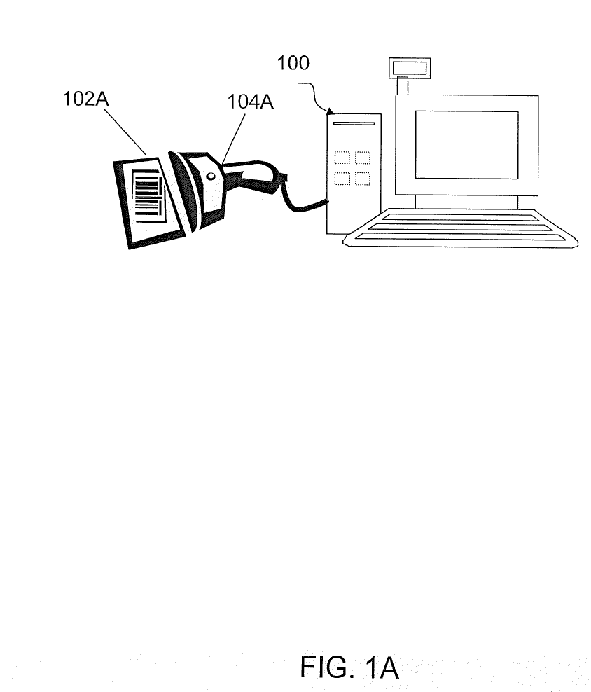

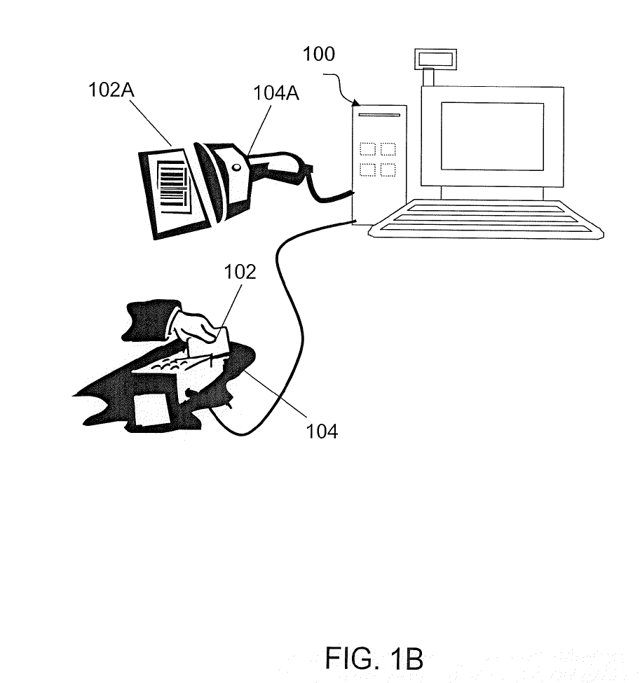

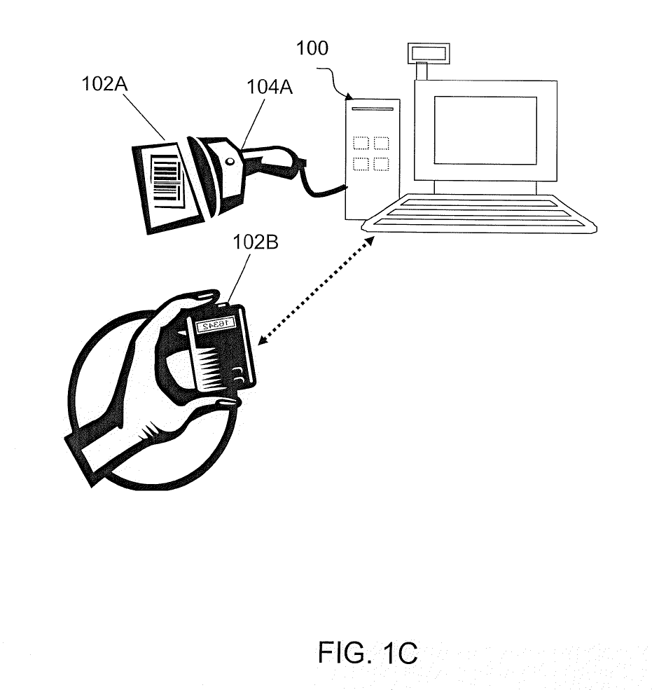

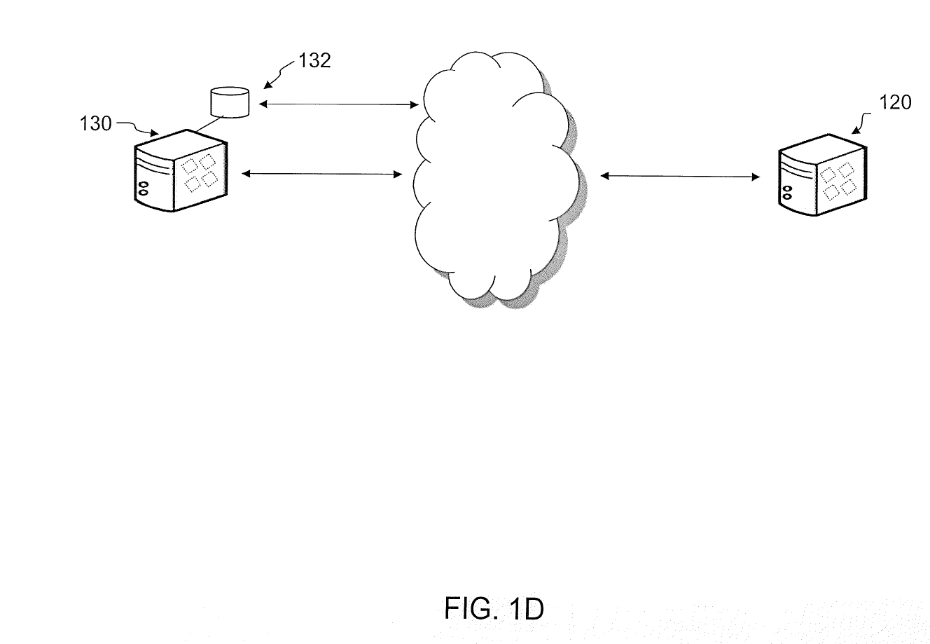

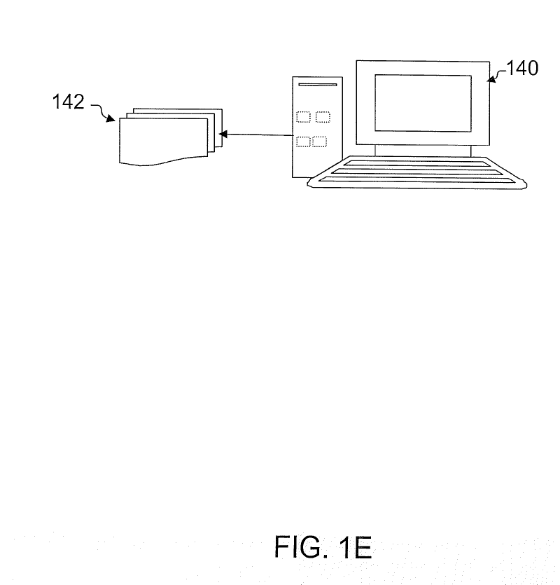

A commercial transaction system and methods can be used for generating and/or capturing transactional data that can include at least some data relating to at least one of an individual item/service sold during the transaction and thereafter the transactional data can be managed. FIG. 1 illustrates an embodiment of such a system.

Referring to FIG. 1, in exemplary embodiments, transactional data may be generated and/or captured at the point of sale using, for example, point-of-sale system 100 at the time of purchase of desired goods and/or services. As shown in FIGS. 1A-1C, point-of-sale system 100 can include an account reader 104 and/or product reader 104A that can read in transactional data related to key card 102 and/or a product/service 102A.

At the time of sale, point-of-sale system 100 can generate a list of the individual items being purchased, as known in the art, such as by scanning identification information using, for example, product reader 104A from a stock-keeping unit (SKU) number, bar code, Radio Frequency Identification (RFID), and/or magnetic strips affiliated with items being purchased or by manual entry of information associated with the items being purchased (e.g., sku number, quantity, price, etc.). Such information may be typically included on items or packing when sold.

When scanning a product/service 102A as illustrated in FIG. 1A, information from a product/service 102A being purchased can be read in by a product reader 104A as, for example, transactional data. Product reader 104A can communicate with the point-of-sale system 100 either by a direct physical link and/or a wireless connection, such as Wi-Fi or Bluetooth.

Account reader 104 and/or Product reader 104A, can be any reader such as, but not limited to, a magnetic strip reader, a bar code reader, a proximity reader, a smart card reader, a biometric reader, and any other reasonable reader for obtaining at least some transactional data from key card 102 and/or a product/service 102A sold.

Point-of-sale system 100 can then generate either an electronic record and/or a paper record of the transactional data. Information regarding the credit card and/or debit card account to be charged for the transaction may be stored on a key card 102 to be used by the point-of-sale system 100.

In exemplary embodiments, the electronic record of the transactional data can be transmitted along with electronic data seeking credit approval from the point-of-sale system 100 to a transaction authorization system 120.

The transactional data can be generated by the point-of-sale system 100 in the form of an electronic receipt which includes itemization data associated with an itemization of individual items purchased in a transaction. The itemization data can include item identification data such as, but not limited to, stock-keeping unit numbers data, pricing data, code data, manufacturer data, product type data, time of sale data, date of sale data, and any other reasonable form of data that can be related to an item/service sold during a transaction, to name a few. Code data can be, but is not limited to data associated with whether the item is deductible, non-deductible, or any other reasonable data that can be used for codification. Product type data can be data associated with the type of product, such as, but not limited to food, beverage, clothing, automotive, gasoline, or any other reasonable data associated with the type of product.

Still referring to FIG. 1, transactional data from a key card 102 and/or transactional data from a product/service 102A sold can be entered at a point-of-sale system 100 and can be communicated to a transaction authorization system 120.

Key card 102 can include, but is not limited to, a physical body, a magnetic strip (e.g., that can be read at the point-of-sale), and built-in security (e.g., a personal identification number, photographic identification, one or more fingerprints, at least one facial measurement, biometric identification, automated notification to a business or individual if unauthorized use is attempted or occurs, etc.). Key card 102 can be an electronic, optically, and/or magnetically encoded card and/or can be associated with one or more accounts.

The electronic record can be captured through a customer device, such as, by way of example, key card 102 or a portal in a mobile electronic device 102A (e.g., a personal digital assistant, smart phone, etc.). Portal can be Bluetooth, wife, optical scan using a camera, to name a few.

When a key card 102 is used as illustrated in FIG. 1B, transactional data can be captured and stored on a chip or other memory device embedded in key card 102, account reader 104, and/or point-of-sale system 100. The key card 102 and/or account reader 104 can communicate with the point-of-sale system 100 either by a direct physical link and/or a wireless connection, such as Wi-Fi or Bluetooth. The electronic record information can then be retrieved later by the system through a direct physical link and/or a wireless connection at a different location. Account information regarding the key card 102 can be provided to the point-of-sale system 100 either by manually entering information displayed physically on the key card, and/or through using Automatic Identification and Data Capture (AIDC) techniques such as, but not limited to, bar codes, Radio Frequency Identification (RFID), magnetic strips, Optical Character Recognition (OCR), smart cards, or any other technique known in the art or hereafter developed.

When a mobile electronic device 102B is used as illustrated in FIG. 1C, the transactional data may be captured by an optical connection (e.g., through an image captured by a camera, etc.) or an electronic connection (e.g., through a Wi-Fi connection, Bluetooth connection, direct link, etc.).

Transactional data can also be captured from, for example, a paper receipt 106, either by manually input and/or input using Automatic Identification and Data Capture (AIDC) techniques such as, but not limited to, reading bar codes from items purchased, Optical Character Recognition (OCR), etc. or any other technique that can at least one of identify the item/service sold, collect data about item/service. It will be understood that any reasonable method for receiving transactional data can be used and any reference to any technique herein can be interchanged. Any reference to a particular technique is for ease and is not in any way meant to be a limitation.

In exemplary embodiments, key card 102 can be combined into an affiliated card (e.g., a credit card, debit card, etc.), a separate and distinct card (e.g., stand alone unit/card), and/or can be combined into a mobile electronic device. In exemplary embodiments, key card 102 can include transactional data, such as, expense destination information (e.g., a job number, project name, etc.) read at the point-of-sale. In exemplary embodiments, key card 102 can be presented in addition to the presentation of a monetary instrument (e.g., check, etc.). In exemplary embodiments, the key card 102 or mobile electronic device 102B can be a card consolidator such that one physical card can represent a plurality of credit and/or debit accounts. The credit and/or debit accounts may be issued by the same or different credit card issuers and/or debit card issuers. A user can select at the time of purchase or thereafter which account or accounts to charge an entire transaction and/or part of a transaction. By way of example, a card consolidator can include at least a company charge account and a personal charge account, where for any given purchase an employee can charge to an employer the company charge account items purchased for the employer, and to the personal charge account, items purchased for personal consumption. Similarly, the card consolidator, by way of example, can also include separate company charge accounts which are each associated with a different client, matter or other cost code, so that an employee can keep track of which cost center particular items purchased should be charged to at the time of purchase or allocated to thereafter. Other combinations of charge accounts may also be used consistent with the present invention.

Referring to FIG. 1D, in exemplary embodiments, transactional data received by transaction authorization system 120 from point-of-sale system 100 (not shown) can be used to grant or deny the entire sale or a portion of it. If denied, a consumer may be required to start the purchasing process over again.

If granted, point-of-sale system 100 (not shown) can communicate the transactional data to a transaction system 130 having a transactional database 132. Transactional database 132 can be located within transaction system 130 (e.g., stored in processor readable memory) or can be located external to transaction system 130 (e.g., transactional database can be located in external memory).

Referring to FIG. 1E, transaction system 130 (not shown) can be in communication with a one or more customer system access point 140 such that, transactional data can be used to generate a report 142. Customer system access point 140 can be, but is not limited to, a personal computer, notebook computer, telephone, cell phone, personal digital assistant (PDA), Blackberry®, smart phone, and any other reasonable electronic device that can be used to access the transactional data and/or other account information.

In exemplary embodiments, reports 142 can be generated based at least in part on transactional data and/or other account information. Reports 142 can include digital reports (e.g., stored in memory), physical reports (e.g., printed paper reports), or a combination of both. Reports 142 can be also be sorted and/or filtered.

In exemplary embodiments, captured transactional data can be differentiated by individual item. For example, individual items within a single purchase can be distinguished within the transactional data and this transactional data relating to individual items in a purchase can be used to generate reports relating to individual items purchased, not simply the entire sale. Further, transactional data relating to individual items can be stored data which can be added to over time.

In exemplary embodiments, the captured transactional data can be managed (e.g., categorized, tracked, compiled, stored, segregated, itemized, aggregated, etc.). For example, the transactional data can be used to populate fields in a display shown at a customer access point (e.g., computer, mobile electronic device, etc.) such that a customer can use the information in these populated fields to generate reports (e.g., expenses reports, deductible items reports, etc.).

In exemplary embodiments, customer access point 140 can receive transactional data associated with a transactional card 102 and/or a mobile electronic device 102B. This transactional data can be used to gain access to transactional data related to that card 102 and/or mobile electronic device 102B. For example, a user can swipe a transactional card 102 on reader (not shown) and gain access to transactional data to generate a report 142.

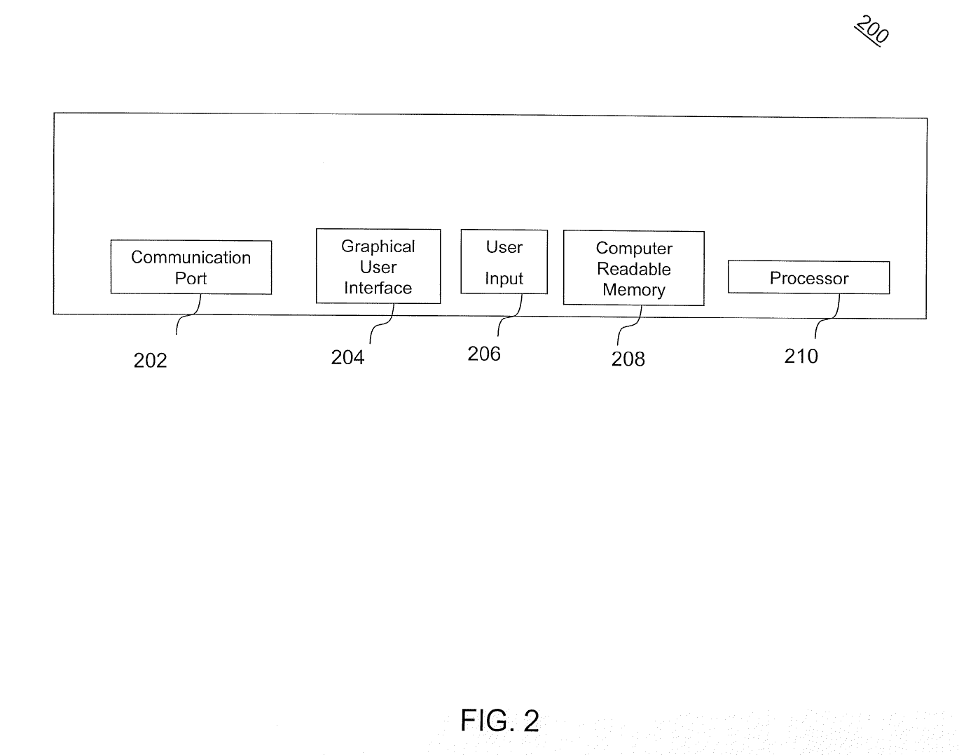

Referring to FIG. 2, in exemplary embodiments, each of point-of-sale system 100, account reader 104, product reader 104A, transaction authorization system 120, transaction system 130, and customer access point 140 can include, but are not limited to, an electronic system/device 200 (e.g., computer, server, etc.) that can include, but is not limited to, at least one of a one or more communications port 202, a one or more graphical user interface 204, at least one or more user input 206, a one or more processor readable memory 208, and a one or more processor 210, and any other reasonable components for communicating and/or analyzing data. In some instances, graphical user interface 204 and the at least one user input 206 can be substantially the same. For example, graphical user interface 208 and the at least one user input can be combined as a touch screen (e.g., a display that can detect the presence and location of a touch within the display area). In some instances, electronic system/device 200 can not include at least one of a graphical user interface 204 and the at least one user input 206 as part of the device or different device.

In exemplary embodiments, each of point-of-sale system 100, account reader 104, product reader 104A, transaction authorization system 120, transaction system 130, database 132 stored on processor readable memory, and customer access point 140 can be in communication with each other using a network (e.g., the internet, a private network, a mobile network, etc.). While illustratively depicted as a network each of the above can be in communication with each other using direct connections or any other reasonable connections known or foreseeable in the future. Further, transactional data can be communicated (e.g., transmitted) as data packets using standard transmission techniques.

It will be understood that each of point-of-sale system 100, account reader 104, product reader 104A, transaction authorization system 120, transaction system 130, and/or customer access point 140 can be combined or further divided. For ease, each of each of point-of-sale system 100, account reader 104, product reader 104A, transaction authorization system 120, transaction system 130, and customer access point 140 are described as separate, this is not in any way meant to be a limitation. Further, point-of-sale system 100 can be a cash register and can display information, such as pricing for items and total cost.

In exemplary embodiments, transactional data (e.g., transactional data packets) can be at least one of received and transmitted by communication port 202 and stored in processor readable memory 208. Further, transactional data can be accessed from processor readable memory 208, and processed (e.g., categorizing) by processor 210. This processed transactional data, can be displayed in graphical user interface 204 and can be further modified (e.g., categorizing, re-categorized, etc.) by consumer interactions with at least one of graphical user interface 204 and user input 206. The transactional data can be displayed in graphical user interface 204 in the form of a report page (e.g., web report page, program report page, etc.) and the transactional data can be modified (e.g., using the techniques herein) by the user and refreshed in graphical user interface 204. The user can be a credit card holder, authorized account administrator, etc. In exemplary embodiments, the transactional data can be displayed in the graphical user interface, transmitted in written reports, printed in written reports (e.g., in a pdf format, in a word format, in an excel format, etc.)

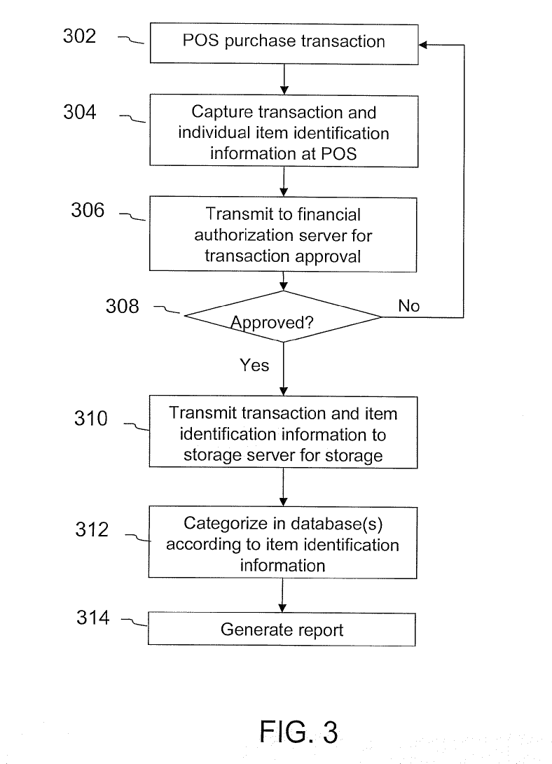

Referring to FIG. 3, in exemplary embodiments, at point-of-sale system 100 a sale can occur, at step 302, and transactional data can be captured (e.g., read in), at step 304. As described above, this transactional data can be related to the product/service sold (e.g., item identification information) and/or transactional data related to key card 102. At step, 306, this transactional data can be communicated (e.g., transmitted as data packets) from point-of-sale system 100 to transaction authorization system 120. By way of example, at a point-of-sale, customer/employee (e.g., a truck driver) working for an employer (e.g., trucking company) can attempt a personal purchase (e.g., a beverage for consumption) and a work related expense (e.g., gasoline for a company truck) using his corporate credit card, and transactional data (e.g., based on the corporate credit card, the object purchased, or any combination thereof) can be generated and transmitted for approval.

The transactional data can be used to approve or deny at least one of an individual item and an entire purchase. If at least one individual item is denied, the consumer can be allowed to purchase the items, however, a list of denied items can be stored on processor readable memory in an election log (e.g., related/added/linked to transactional data, added to a file to the transactional data, etc.) of approved and/or denied items in the transactional data, at step 308. If denied, a consumer may be required to start the purchasing process over again returning to step 302. Following the above example, the trucker's purchase of both a beverage and gasoline using a corporate credit card may be denied because, based on the transactional data, transaction authorization system 120 may determine that the purchase of a beverage is not allowed. In exemplary embodiments, a log of approved and/or denied items can be transmitted to transaction system 130 by, for example, following the steps below. Following the above example, the trucker's purchase of both a beverage and gasoline using a corporate credit card may be denied because, based on the transactional data, transaction authorization system 120 may determine that the purchase a personal item (e.g., a beverage for personal consumption) is not allowed, however, the truck driver can still purchase the beverage and gasoline because the transactional data can be modified, or have a file added/linked to it, to indicate that this was a personal purchase. In exemplary embodiments, a personal purchase (e.g., a beverage) can be separated from a non-personal purchase (e.g., gasoline) and the personal purchase can be put on a personal account.

Further, rules for approving and denying can be based on rates saved on the system. Rules for approving and denying can be present by automated entity or tailored by the card holder or employer.

If approved, transactional data (e.g., item identification information) can be transmitted to point-of-sale system 100 and can then be transmitted to transaction system 130 that can have a transactional database 132, at step 310. Transactional data can be stored in a customer account related to that specific customer, a business the customer is affiliated with, or an item that account is related to (e.g., a home, a car, a boat, etc.).

In exemplary embodiments, a customer, a company affiliated with that customer, or an authorized individual (e.g., accountant, auditor, etc.) can access the transaction system using customer system access point 140 and can categorize the various data based on a plurality of categories, at step 312. Further, based on these various categorizations the customer, a company affiliated with the customer, or an authorized individual can generate a report based on the categorized data, at step 314. Following the above example, the trucking company and/or the truck driver can access the transaction system 130, for example, using a computer, and generated reports (e.g., to show a list of deductible items, to show maintenance and care of the truck, itemizing who pays for what sale, who obtains deductibility benefits from sale items, etc.). For example, because the transaction data includes information related to each individual item, reports can be generated based on individual items in at least one transaction, not simply the transaction as a whole.

In exemplary embodiments, a customer, a company affiliated with that customer, or an authorized individual (e.g., accountant, auditor, etc.) can access the transaction system using customer system access point 140 and use transactional data for corporate governance and/or auditing. An auditor can access the transaction system using customer system access point 140 and can audit transactions. For example, an auditor can audit a CEO or other employee to determine what was purchased during a transaction and determine whether or not the entire transaction or elements of the transaction are unauthorized.

In exemplary embodiments, a custodian or a lender can access the transaction system using customer system access point 140 and use transactional data to monitor spending. For example, a parent can access transactional data in order to determine if a child is purchasing items that they are restricted from purchasing. As another example, a university can access transactional data to determine if money from a loan is being spent as intended by the university.

It will be understood that transactional data can be accessed automatically by a processor readable program and/or by a user (e.g., a parent, auditor, etc.), and/or by any combination therein. Further, it will be understood that the transactional data can be accessed for any reasonable use and transactional data can be accessed for a single transaction, a series of transactions, a plurality of transactions, or any combination thereof to access information about an item in a transaction, a plurality of items in a transaction, the transaction as a whole, or any combination thereof.

In exemplary embodiments, information from a transaction can be used to categorize user spending habits. Further, spending habit reports can be generated from the transactional data that can be used for marketing, sales, tracking routes, or for any other reasonable use.

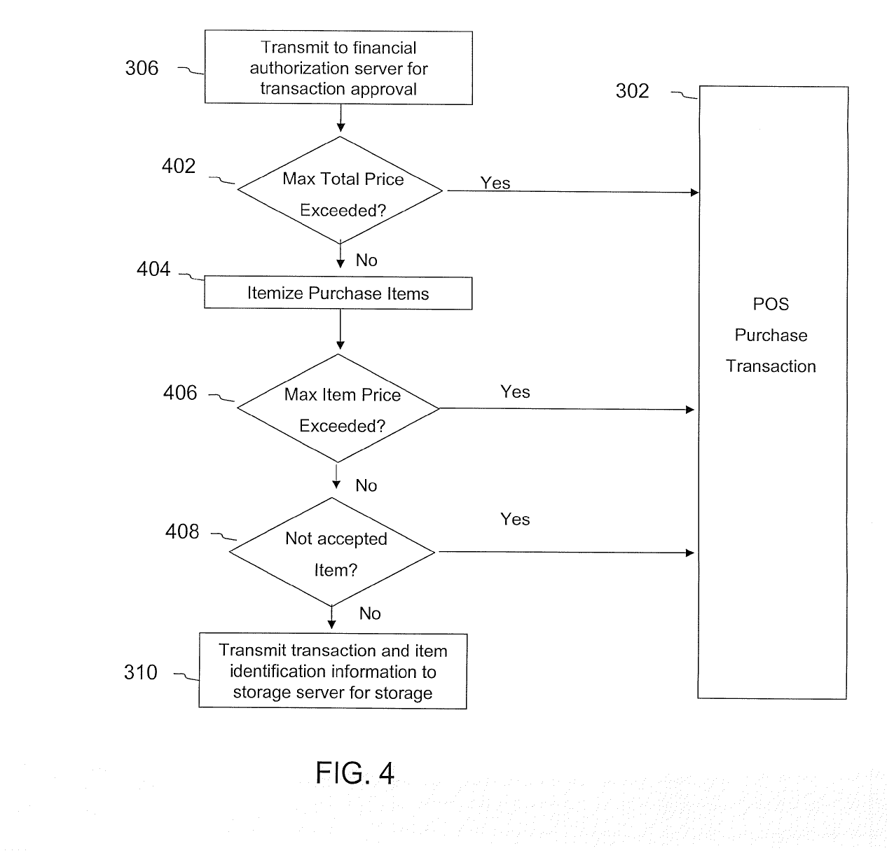

Referring to FIG. 4, in exemplary embodiments, transaction authorization system 120 can approve or deny a transaction based on transactional data such as, but not limited to, price of the total purchase, price of an individual item, type of sale item, or any other reasonable category. The steps shown herein can be implemented in determining to approve and/or deny a sale, for example, as accomplished in step 308 in FIG. 3. Further, each of the steps provided below can be combined, further divided, or taken out of sequence without deviating from the scope of the invention.

At step 306, transactional data can be transmitted to transaction authorization system 120. In exemplary embodiments, at step 402, transaction authorization system 120 can determine if the total sale price exceeds a maximum limit. For example, transaction authorization system 120 can determine the total sale price and confirm it does not exceed the maximum spending limit for a complete transaction (e.g., above $50, $100, $1000, $10000, etc.). If exceeded, the sale may be denied and a customer may be required to start the purchasing process over again returning to step 302.

If approved, the sale items can be itemized (e.g., by SKU numbering, etc.), at step 404, and these itemized items can then be analyzed to determine if any individual item exceeds a maximum price for an individual item, at step 406. For example, transaction authorization system 120 can determine if a maximum spending limit for a single product/service (e.g., $5, $30, $50, $100, $1000, etc.) in a transaction has been exceeded. If exceeded, the sale may be denied and a customer may be required to start the purchasing process over again returning to step 302.

In exemplary embodiments, a spending limit for an item and/or an entire transaction can be modified after an individual authorized to represent a company (e.g., trucker, trucking company representative, an accountant for the trucking company, etc.) is authorized (e.g., enters a pass code, passes a biometric test, etc.) to change the set limit. For example, a representative of a company (e.g., an accountant for a trucking company) can access the spending limit after entering in a pin number and can then increase or decrease the limit.

If approved, each of the sale items can be individually confirmed as being an accepted category such as, but not limited to, home office expense, uniform expense, bill, food, gasoline, inappropriate item, or any other reasonable category for determining if a sale item can be approved. For example, transaction authorization system 120 can determine which category each sale items belongs in (e.g., using the SKU numbering, etc.), and determine if the item is accepted or If an un-accepted item is found, the sale may be denied and a customer may be required to start the purchasing process over again returning to step 302. If no un-accepted items are found, then the transactional data can be transmitted to transaction system, at step 310.

In exemplary embodiments, transaction system 130 can include an account and/or be in communication with an account such as, but not limited to, on-line bank accounts, non-Internet bank accounts with on-line records access and/or automated bill paying service, credit union accounts with on-line records access and/or automated bill paying service, brokerage accounts with on-line records access and/or automated bill paying service, the database of any other online bill-paying or banking system, or any other reasonable form of electronic account. In exemplary embodiments, transaction system 130 and/or any other system can be in communication with many systems.

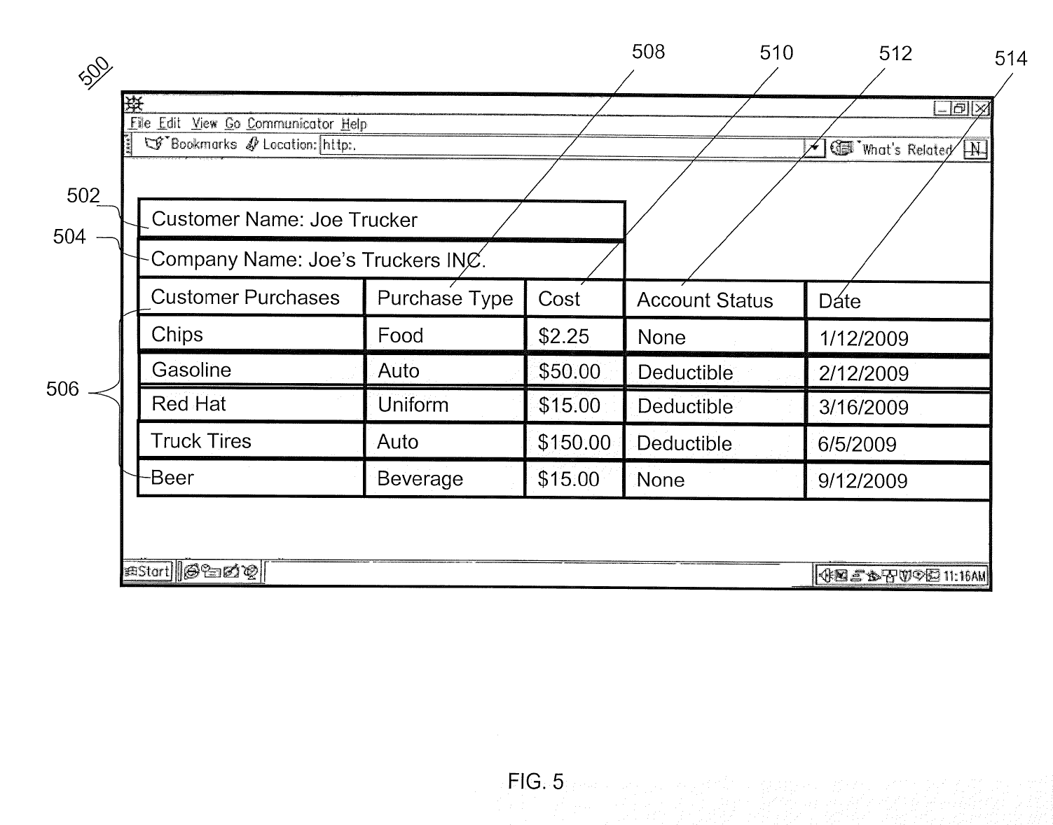

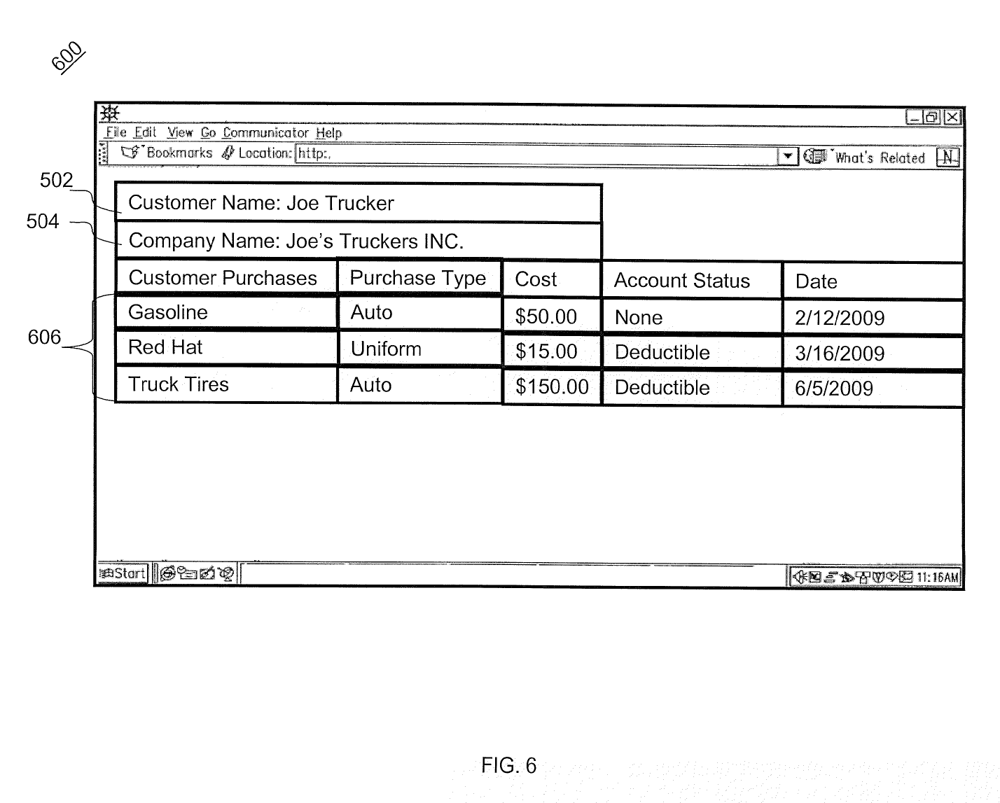

Referring to FIGS. 5-6, in exemplary embodiments, a customer or representative of the customer (e.g., an accountant, employer, employee, etc.) can access transaction system 130 and modify transactional data (e.g., sort, filter, compile, categorize, etc.) based on at least one of but not limited to, purchase type (e.g., auto, uniform, beverage, gasoline, utilities, etc.), value/cost (e.g., types of currency), accounting status (e.g., deductible, non-deductible, etc.), date (e.g., fiscal year, quarter, month, etc.), and any other reasonable form of organization and/or modification to transactional data.

Referring to FIG. 5, in exemplary embodiments, a report page 500 can display an itemized list of sale items (e.g., based on at least a portion of the transactional data) on graphical user interface 204 of customer system access point 140. As shown, report page 500 can include, but is not limited to, at least one of a customer name 502 (e.g., Joe Trucker), a company name 504 (e.g., Joe's Truckers INC.), and a list of sale items 506 (e.g., chips, gasoline, red hat, truck tires, beer). Further, in exemplary embodiments, each of sale items 506 can be broken down into categories such as, but not limited to, at least one of purchase type 508 (e.g., food, auto, uniform, auto, beverage, etc.), cost 510 (e.g., $2.25, $50.00, $15.00, $150.00, $15.00, etc.), accounting status 512 (e.g., none, deductible, etc.), and date 514 (e.g., 1/12/2009, 2/12/2009, 3/16/2009, 6/5/2009, and 9/12/2009, etc.). It will be understood that other reports can be generated consistent with the present invention.

In exemplary embodiments, an itemized list (e.g., based on at least a part of the transactional data) can be aggregated. For example, purchases can be aggregated by the type of purchase (e.g., all food purchases, all gas purchases, personal purchases, non-personal purchases, etc.). In exemplary embodiments, transactional data associated with a plurality of cards can be aggregated. For example, an itemized list can display all transactional data for a plurality of credit cards.

Referring to FIG. 6, in exemplary embodiments, any of sale items 506 can be further modified, for example, to display more relevant information. For example, if Joe Trucker is not reimbursed by Joe's Truckers INC. for his business expenses he may only want to have an itemized list for accounting purposes of deductible items. Similarly, a representative of Joe's trucking Inc can create an itemized list of items (e.g., non-deductible expenses by Joe Trucker, deductible expenses by Joe Trucker, etc.). It will be understood that either any individual authorized to make purchases for a company and/or an individual authorized by a company can create itemized lists of items. Accordingly, report page 500 can be modified to only show those sales which are deductible. As shown, report page 600 populates only deductible items in the list of sales 606. It will be understood that an itemized list of sales can be modified to show any reasonable list based on any reasonable category.

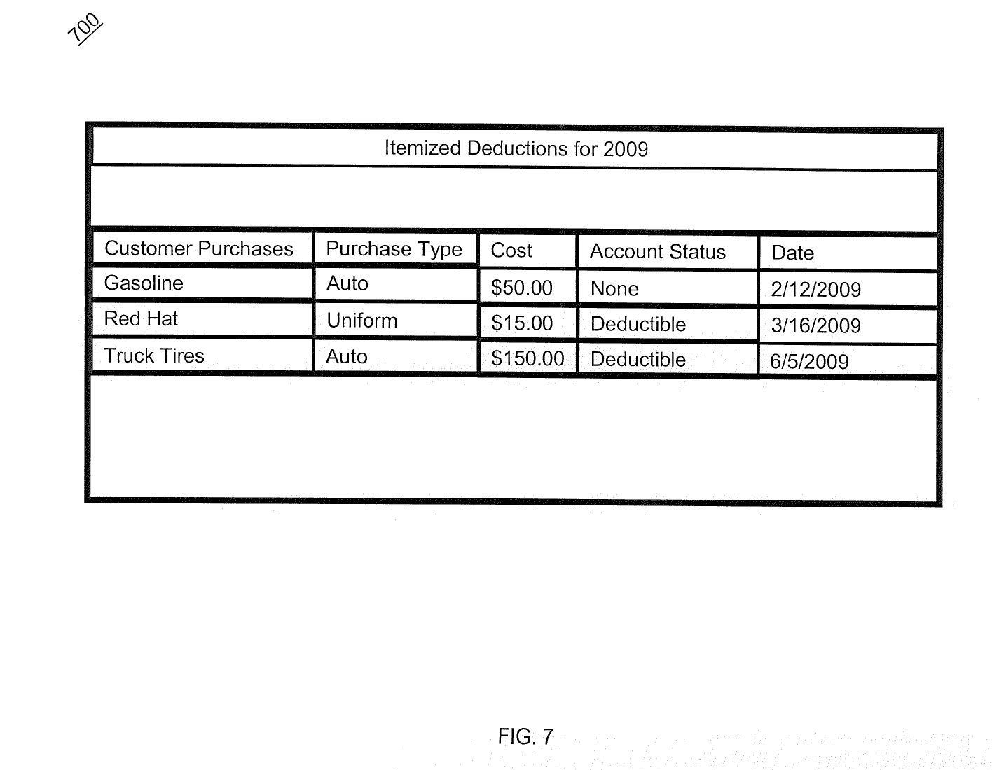

Referring to FIG. 7, in exemplary embodiments, the modified transactional data (e.g., sorted, filtered, compiled, categorized, etc.) can be incorporated in a modified transactional data report (e.g., printed report, electronic report, etc.). For example, the modified transactional data report can be use by at least one of but not limited to, an accountant, a customer, an affiliate of a customer, a company or organization a customer purchases for, an independent calculator, an electronic accounting software product (e.g., Quicken®, etc.) and/or government filing software (e.g., TURBO TAX®, taxsoftware.com®, etc.) and can be filed as a part of the income information provided to an authority (e.g., the Internal Revenue Service). As shown, the previous list of deductible sales, displayed in FIG. 6, can be used to generate an Itemized Deductions List 700 that can be filed in a form or automatically entered into a software for listing deductions.

In exemplary embodiments, transactional data from the electronic receipt can be used for accounting preparation and filing. For example, transactional data can be used in conjunction with accounting preparation and filing software such that fields in the software can be automatically populated. Deduction information can be modified (e.g., sorted, filtered, compiled, and categorized) and stored in the electronic account (e.g., in a spreadsheet, etc.) in a format that can be directly or indirectly used by an independent accounting calculation and electronic accounting filing software products. Accordingly, an income filing can be filed on behalf of the consumer thereby minimizing manual user inputs in filing out an income accounting form.

In exemplary embodiments, transactional data, the electronic receipt, and/or transactional data from the electronic receipt can be compatible with an accounting (e.g., tax, payroll, etc.) preparation system and/or can be part of an accounting (e.g., tax, payroll, etc.) preparation system. The systems and methods described herein can include an accounting (e.g., tax, payroll, etc.) preparation system (e.g., a system including information capable of being stored on a processor readable medium and processed by a processor) capable of using transactional data, the electronic receipt, and/or transactional data from the electronic receipt such that at least one of but not limited to, an accountant, a customer, an affiliate of a customer, a company or organization a customer purchases for, or any other reasonable person/company can file accounting documents (e.g., tax forms, pay stubs, etc) using the system provided.

Further, the transactional data can also be used for tracking purchases and other expenses related to specific entity (e.g., a house, motor vehicle, location, etc.) for establishing a records related to that entity (e.g., maintenance record, improvements records, etc.) that can be used in determining the resale value of that entity.

In exemplary embodiments, the transactional data can include location information. Transactional data including location information can be used for marketing, sales, and distribution purposes. For example, a manufacturer (e.g., chip producer) can access all the transactional data for a region in order to determine where their product is being purchased and/or whether or not marketing in an area is working.

In exemplary embodiments, the transactional data can be used to display the location of purchases and/or what was purchased at a location in a graphical user interface, for example, on a map. For example, an employer can access the transactional data for an employee and view it on a map in order to tell where purchases were made by an employee and/or what was purchased. By way of example, an employer (e.g., a trucking company) can access the transactional data for an employee (e.g., a trucker) for a specific period of time (e.g., during a delivery) and view on a map where purchases by the employee were located on a map and/or what was purchased at that location in order to tell how off route the employee (e.g., trucker) went to purchase restricted items (e.g., beer).

Now that exemplary embodiments of the present invention have been shown and described in detail, various modifications and improvements thereon will become readily apparent to those skilled in the art. For example, while some examples of uses of the itemized system are discussed other uses are reasonable foreseeable. Accordingly, the spirit and scope of the present invention is to be construed broadly and limited only by the appended claims, and not by the foregoing specification.

1. A method of capturing and transmitting data for a plurality of items sold in a commercial transaction between a consumer and a merchant, the method comprising the steps of:
receiving, at one or more computers transactional data, wherein the transactional data relates to a plurality of individual items sold during the transaction, the transactional data comprising item identification information for each of the plurality of individual items sold and account information;
storing the transactional data on one or more processor readable memory electronically accessible by the one or more computers;
transmitting the transactional data for approval or denial for at least a plurality of items and the entire purchase;
receiving approval or denial for at least a plurality of items and the entire purchase; and
transmitting the transactional data to a database.

2. The method of claim 1, wherein the transmitted transactional data is used to generate a report.

3. The method of claim 2, wherein the report is used for at least one of corporate governance and auditing purposes.

4. The method of claim 2, wherein the report is further comprising location based information.

5. The method of claim 4, further comprising, generating the location based information on a map.

6. The method of claim 2, wherein the report is used by at least one of a parent monitoring the spending of a child and a university monitoring the spending of a student.

7. The method of claim 2, wherein at least one of the transactional data and report can be viewed on a mobile electronic device.

8. The method of claim 1, wherein the account information is captured through a portal in a mobile electronic device.

9. The method of claim 1, wherein the account information is input manually.

10. The method of claim 1, wherein the account information is captured from a card.

11. The method claim of claim 10, wherein the card is affiliated with multiple credit cards.

12. The method of claim 2, wherein the report aggregates account information from at least one of a plurality of credit cards and a plurality of accounts.

13. The method of claim 1, wherein the step of transmitting is done over the internet or other secure connection.

14. The method of claim 1, where the item identification information is further comprising at least one of the type and category of the individual items sold.

15. The method of claim 1, further comprising:
electronically determining a relationship between each of the a plurality of individual items sold and items from existing purchases stored in the database on one or more processor readable memory based on the item identification information,
electronically categorizing each of the a plurality of individual items sold and electronically categorizing each of the a plurality of individual items sold and the items from existing purchases according to the item identification information.

16. The method of claim 2, further comprising:
transmitting to an additional computer the generated report for modification of the item identification information.

17. The method of claim 2, wherein the generated report is a report for at least one of accounting purposes and government filing purposes.

18. The method of claim 1, wherein the transactional data refers to transactions related to at least one of a house, a car, and a boat.

19. The method of claim 1, wherein item identification information is a SKU number.

20. The method of claim 1, wherein the transactional data is generated at the point of sale.

21. The method of claim 1, wherein the transactional data is input at the point of sale.

22. The method of claim 10, wherein the card is a debit card.
